(19) United States
(12) Patent Application Publication
(10) Pub. No.: US 2017/0258657 A1
(43) Pub. Date: Sep. 14, 2017

(54) Patient Transfer System

(71) Applicant: Rudy Llanes, Brazoria, TX (US)

(72) Inventor: Rudy Llanes, Brazoria, TX (US)

(21) Appl. No.: 15/458,019

(22) Filed: Mar. 13, 2017

Related U.S. Application Data
(60) Provisional application No. 62/306,893, filed on Mar. 11, 2016.

(51) Int. Cl. A61G 7/10

(52) U.S. Cl. CPC A61G 7/1026; A61G 7/1044; A61G 7/1057

(57) ABSTRACT

A patient transfer system for transferring a patient from an operating table to a recovery bed is provided. The patient transfer system comprises first and second support members mounted to a first side of the recovery table. First and second hubs are rotatably mounted to the first and second support members, respectively. A rotatable shaft is mounted between the first and second hubs. First strap and second straps are secured to the rotating shaft with the each strap having a free end. A sheeting material is positionable over the operating table with the free ends of the straps secured to the sheeting material. A cranking mechanism rotates the rotatable shaft. Upon positioning the sheeting material on the operating table and rotating the rotatable shaft, the first and second straps spool about the rotating shaft and pull the sheeting material from the operating table to the recovery bed.

### CLAIM OF PRIORITY

This patent application claims priority under 35 USC 119 (e) (1) from U.S. Provisional Patent Application Ser. No. 62/306,893 filed Mar. 11, 2016, of common inventorship herewith entitled, “Patient Transfer Mechanism and Associated Use Thereof With Operating and Recovery Beds,” which is incorporated herein by reference as though the same were set forth in its entirety.

### FIELD OF THE INVENTION

The present invention pertains to the field of patient transfer systems, and more specifically to the field of patient transfer systems providing a hand-cranked mechanism for transferring a post-surgical patient from the operating table to a recovery table or gurney, easily, smoothly, and without physical strain on the part of hospital personnel,

### BACKGROUND OF THE INVENTION

Health care workers at hospitals, nursing homes, and home care programs face the challenge of moving partly or completely incapacitated patients. Due to the weight of many patients, consequently, at least two to four health care workers are usually needed to move the patient. These activities often create unacceptable risks of injury, almost without regard to the number of health care workers used in the patient transfer. The risks are particularly high when a sufficient number of workers is not available to assist in a patient transfer.

Several complex and expensive attempts have been made in the past to provide a means for transferring a hospitalized patient from his bed to a movable, roll around platform or gurney or between such a platform and any other horizontal surface. Often in conveying a patient between such supports it is essential to minimize the stresses placed upon his body and to keep him from exerting his own muscles. The task of conveying a patient under such circumstances is further hindered by the soft deformable nature of the bed or other padded surface. Prior attempts to solve these difficulties have generally involved complex pulling and support mechanisms or bed attachments which are relatively expensive and which are cumbersome and difficult to store when not in use.

### SUMMARY OF THE INVENTION

It is an object of the present invention to provide a patient transfer system having a hand-cranked mechanism for transferring a post-surgical patient from the operating table to a recovery table or gurney, easily, smoothly, and without physical strain on the part of hospital personnel.

The present invention is a patient transfer system for transferring a patient from an operating table to a recovery bed. The recovery bed has a first side and a second side. The patient transfer system comprises a first support member capable of being mounted to the first side of the recovery table and a second support member capable of being mounted to the first side of the recovery table. A first hub is rotatably mounted to the first support member and a second hub is rotatably mounted to the second support member. A rotatable shaft is mounted between the first hub and the second hub. A first strap is secured to the rotating shaft with the first strap having a first free end and a second strap is secured to the rotating shaft with the second strap having a second free end. A sheeting material is positionable over the operating table with the first free end of the first strap and the second free end of the second strap secured to the sheeting material. A cranking mechanism rotates the rotatable shaft. Upon positioning the sheeting material on the operating table, positioning the patient upon the sheeting material, releasably securing the operating table adjacent the second side of the recovery bed, and rotating the rotatable shaft with the cranking mechanism, the first strap and the second strap spool about the rotating shaft and pull the sheeting material and the patient from the operating table to the recovery bed. The patient transfer system allows transfer of the patient from the operating table to the recovery bed without physical strain.

In addition, the present invention includes a method for transferring a patient from an operating table to a recovery bed. The recovery bed has a first side and a second side. The method comprises mounting a first support member to the first side of the recovery table, mounting a second support member to the first side of the recovery table, spacing the first support member from the second support member, rotatably mounting a first hub to the first support member, rotatably mounting a second hub to the second support member, mounting a rotatable shaft between the first hub and the second hub, securing a first strap to the rotating shaft with the first strap having a first free end, securing a second strap to the rotating shaft with the second strap having a second free end, positioning a sheeting material over the operating table, positioning the patient on the sheeting material, releasably securing the operating table adjacent the second side of the recovery bed, securing the first free end of the first strap and the second free end of the second strap to the sheeting material, rotating the rotatable shaft, rolling the first strap and the second strap roll about the rotating shaft, and pulling the sheeting material and the patient from the operating table to the recovery bed.

The present invention further includes a patient transfer system for transferring a patient from an operating table to a recovery bed. The recovery bed has a first side and a second side The patient transfer system comprises a first support member capable of being mounted to the first side of the recovery table with the first support member mounted nearingly adjacent a foot end of the recovery bed and a second support member capable of being mounted to the first side of the recovery table with the first support member spaced from the second support member. A first hub is rotatably mounted to the first support member and a second hub is rotatably mounted to the second support member. A rotatable shaft is mounted between the first hub and the second hub. A first spool is mounted to the rotating shaft between the first hub and the second hub. A first strap is secured to the first spool with the first strap having a first free end and a second strap is secured to the second hub with the second strap having a second free end. A sheeting material is positionable over the operating table with the first free end of the first strap and the second free end of the second strap releasably secured to the sheeting material. A cranking mechanism rotates the rotatable shaft. Upon positioning the sheeting material on the operating table, positioning the patient upon the sheeting material, releasably securing the operating table adjacent the second side of the recovery bed, and rotating the rotatable shaft with the cranking mechanism, the first strap spools about the first spool and the second strap spools about the second hub and pulls the sheeting material and the patient from the operating table to the recovery bed. The patient transfer system allows transfer of the patient from the operating table to the recovery bed without physical strain.

### BRIEF DESCRIPTION OF THE DRAWINGS

FIG. 1 is a perspective view illustrating a patient transfer system, constructed in accordance with the present invention, mounted to a recovery bed.

FIG. 2 is a perspective view illustrating a patient transfer system, constructed in accordance with the present invention, mounted to the recovery bed in coordination with an operation bed.

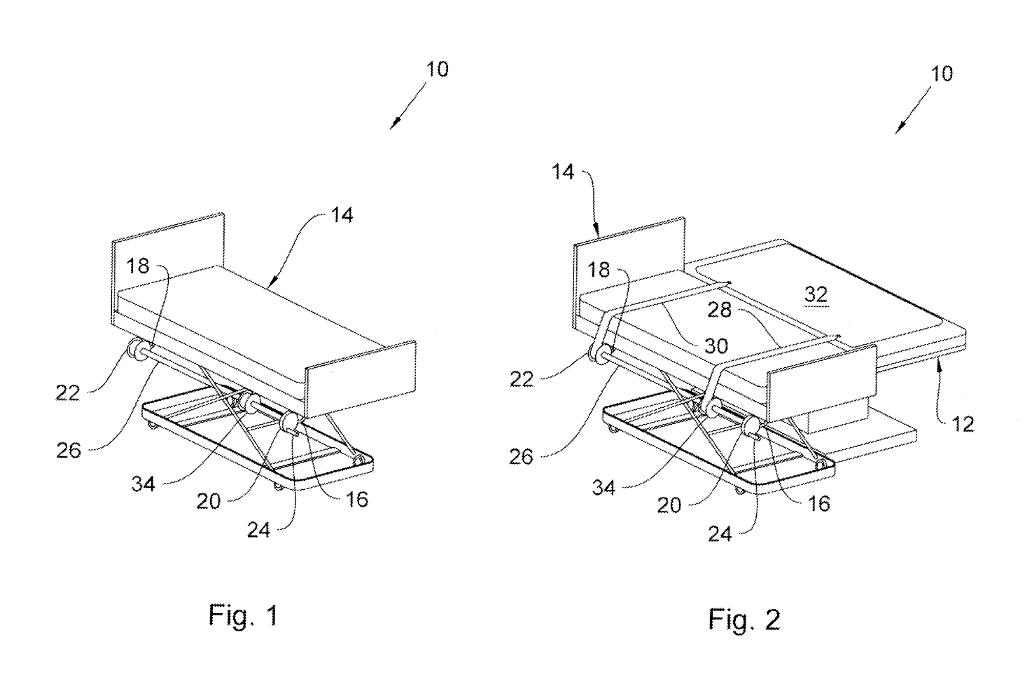

### DETAILED DESCRIPTION OF THE INVENTION

The present invention, hereinafter referred to as a Patient Transfer System, indicated generally at 10, transfers a post-surgical patient from the operating table 12 to a recovery table 14 or gurney, easily, smoothly, and without physical strain on the part of hospital personnel. Incorporated into a gurney or wheeled hospital bed 14, the Patient Transfer System 10 makes the transfer of patients easier on both the patient and on the staff who transfer them from the operating table 14 to the recovery bed 12.

The Patient Transfer System 10 of the present invention includes a first support member 16 and a second support member 18 extending in a generally outward direction from the wheeled hospital bed 14 or gurney (the bed to which the patient is to be transferred from the operating table 12). The first support member 16 and the second support member 18 are spaced from each other and mounted to one side of the hospital bed 14. Preferably, the first support member 16 is mounted nearingly adjacent the foot end of the hospital bed 14 allowing easy access to health care professionals. Also, the first support member 16 and the second support member 18 are preferably mounted below a mattress portion of the hospital bed 14 although mounting the first support member 16 and the second support member 18 at other heights on the side of the hospital bed 14 is within the scope of the present invention.

In addition, the Patient Transfer System 10 of the present invention includes a first hub 20 rotatably mounted to the first support member 16 and a second hub 22 rotatably mounted to the second support member 18. A manually operated hand crank 24 is mounted to the first hub 20 allowing a health care professional the ability to easily rotate the first hub 20, as will be described in further detail below. It should be noted that while the cranking of the Patient Transfer System 10 has been described as being a manually operated hand crank 24, it is within the scope of the present invention for the hand crank 34 to be replaced by a motor rotated and activated by operating controls either remotely situated or mounted directly to the hospital bed 14.

Additionally, the Patient Transfer System 10 of the present invention includes a rotatable shaft 26 having a first end and a second end. The rotatable shaft 26 is mounted between the first hub 20 and the second hub 22 with the first end of the rotatable shaft 26 mounted to the first hub 20 and the second end of the rotatable shaft 26 mounted to the second hub 22. As will be understood by those persons skilled in the art, the rotation of the first hub 20 by the hand crank 24 also rotates the rotating shaft 26 and the second hub 22.

The Patient Transfer System 10 of the present invention further includes a first strap 28 rolled around the rotating shaft 26 and a second strap 30, spaced from the first strap 28, rolled around the rotating shaft 26. Preferably, the first strap 28 and the second strap 30 are constructed from a nylon material although constructing the first strap 28 and/or the second strap 30 from a different material including, but not limited to, leather, plastic, cloth, etc., is within the scope of the present invention.

Each of the first strap 28 and the second strap 30 of the Patient Transfer System 10 of the present invention have a free end extending from the rotating shaft 26. The free ends of the first strap 28 and the second strap 30 are securable to a sheeting material 32 to actually move the patient, as will be described further below.

In a preferred embodiment, the Patient Transfer System 10 of the present invention includes a first spool 34 mounted to the rotating shaft 26 between the first hub 20 and the second hub 22. The first spool 34 can be fixedly secured to rotating shaft 26 such that the first spool 34 rotates with the rotation of the rotating shaft 26, or the first spool 34 can be slidably mounted on the rotating shaft 26 allowing the position of the first s pool 34 between the first hub 20 and the second hub 22 to be adjusted and changed. In the former embodiment, the first spool 34 is preferably fixedly secured to the rotating shaft 26 at a position nearingly adjacent the first hub 20, which is a position closer to the first hub 20 than the second hub 22. In the latter embodiment, a locking mechanism is provided to releasably secure the first spool 34 in a desired position along the rotating shaft 26 and allowing the first spool 34 to rotate with the rotation of the rotating shaft 26.

With the first spool 34 of the Patient Transfer System 10 of the present invention, the first strap 28 is spooled around the first spool 34 and the second strap 30 is spooled around the second hub 22, which can operate as a second spool. Or, in the alternative, in an embodiment without the first spool 34, the first strap 28 is spooled around the first hub 20, which can operate as an additional spool, and the second strap 30 is spooled around the second hub 22. In either embodiment, the free ends of the first strap 28 and the second strap 30 operate as described, attached to the sheeting material 32.

The sheeting material 32 of the Patient Transfer System 10 of the present invention is preferably constructed from a resilient, roiled length of heavy-duty, double-thick hospital sheet or a length of rubber sheeting. The free ends of the first strap 28 and the second strap 30 are releasably secured along one edge of the sheeting material 32 allowing the sheeting material 32 to be moved upon rotation of the rotating shaft 26.

In operation, the health care professional simply removes the sheeting material 32 of the Patient Transfer System 10 of the present invention from its sterile packaging. Prior to surgery, the sheeting material 32 is unrolled and spread out on the operating table 12 or sending bed prior to the patient getting upon the operating table 12 or sending bed. As stated above, the first hub 20, the second hub 22, and the rotating shaft 26 are mounted to one side of the hospital or receiving bed 14. When surgery is complete, or the patient is ready for transfer to recovery, the other side of the hospital or receiving bed 14 is releasably secured to the operating table 12 or sending bed, preferably at both the head and foot area. Securement of the hospital or receiving bed 14 to the operating table 12 or sending bed can be accomplished by hooks, buckles, straps, hook and loop fasteners, etc. The free ends of the first strap 28 and the second strap 30 are secured along the edge of the sheeting material 32. Upon operation of the hand crank 24, the sheeting material 32 is pulled across the operating table 12 or sending bed and upon the hospital or receiving across from the operating table 12 to the hospitable or receiving bed 14 or gurney. The Patient Transfer System 10 can be geared to further reduce the need for physical strength in operating it. Once the patient has been successfully transferred to the recovery bed 14 or gurney, the sheeting material 32, whether a double-thick hospital sheet or a rubber or synthetic material, is removed from beneath the patient to be sterilized, packaged, and ready for its next use.

The Patient Transfer System 10 of the present invention eases the back strain to which health care professionals are subjected when transferring patients, something that both they and their employers (who pay for Workers Compensation insurance) will greatly appreciate. For the surgical patient, the Patient Transfer System 10 makes the transfer process simple, smooth, reliable, and gentle. And, because the Patient Transfer System 10 can be incorporated into hospital beds 14 and gurneys as an add-on, aftermarket accessory, the cost of the Patient Transfer system 10 is a mere fraction of the cost of a new bed or gurney, again, something that will please hospital administrators and purchasing agents. Thus, the Patient Transfer System 10 meets a real need shared by hospitals, hospital personnel, and hospital patients.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A patient transfer system for transferring a patient from an operating table to a recovery bed, the recovery bed having a first side and a second side, the patient transfer system comprising:
a first support member capable of being mounted to the first side of the recovery table;
a second support member capable of being mounted to the first side of the recovery table;
a first hub rotatably mounted to the first support member;
a second hub rotatably mounted to the second support member;
a rotatable shaft mounted between the first hub and the second hub;
a first strap secured to the rotating shaft, the first strap having a first free end;
a second strap secured to the rotating shaft, the second strap having a second free end;
a sheeting material positionable over the operating table, the first free end of the first strap and the second free end of the second strap secured to the sheeting material; and
a cranking mechanism for rotating the rotatable shaft;
wherein upon positioning the sheeting material on the operating table, positioning the patient upon the sheeting material, releasably securing the operating table adjacent the second side of the recovery bed, and rotating the rotatable shaft with the cranking mechanism, the first strap and the second strap spool about the rotating shaft and pull the sheeting material and the patient from the operating table to the recovery bed; and
wherein the patient transfer system allows transfer of the patient from the operating table to the recovery bed without physical strain.

2. The patient transfer system of claim 1 wherein the first support member and the second support member are spaced from each other and mounted to one side of the recovery bed.

3. The patient transfer system of claim 2 wherein the first support member is mounted nearingly adjacent a foot end of the recovery bed.

4. The patient transfer system of claim 1 wherein the first support member and the second support member are mounted below a mattress portion of the recovery bed.

5. The patient transfer system of claim 1 wherein the cranking mechanism is a manually operated hand crank mounted to the first hub.

6. The patient transfer system of claim 1 wherein the cranking mechanism is a motor activatable by operating controls either remotely situated or mounted directly to the hospital bed.

7. The patient transfer system of claim 1 and further comprising:
a first spool mounted to the rotating shaft between the first hub and the second hub;
wherein the first strap rollable about the first spool; and
wherein the second strap is rollable about the second hub.

8. The patient transfer system of claim 7 wherein the first spool is fixedly secured to rotating shaft, first spool rotating with the rotation of the rotating shaft.

9. The patient transfer system of claim 8 wherein the first spool is fixedly secured to the rotating shaft at a position nearingly adjacent the first hub at a position closer to the first hub than the second hub.

10. The patient transfer system of claim 7 wherein the first spool is slidably mounted along the rotating shaft, and further comprising:
a locking mechanism for releasably securing the first spool in a desired position along the rotating shaft, the first spool rotating with the rotation of the rotating shaft.

11. The patient transfer system of claim 1 wherein the first strap is spooled around the first hub and the second strap is spooled around the second hub.

12. The patient transfer system of claim 1 wherein the free ends of the first strap and the second strap are releasably secured along one edge of the sheeting material.

13. The patient transfer system of claim 1 wherein the hospital bed is secured to the operating table by a fastening mechanism selected from the group consisting of hooks, buckles, straps, and hook and loop fasteners.

14. A method for transferring a patient from an operating table to a recovery bed, the recovery bed having a first side and a second side, the method comprising:
mounting a first support member to the first side of the recovery table;
mounting a second support member to the first side of the recovery table;
spacing the first support member from the second support member;
rotatably mounting a first hub to the first support member;
rotatably mounting a second hub to the second support member;
mounting a rotatable shaft between the first hub and the second hub;
securing a first strap to the rotating shaft, the first strap having a first free end;
securing a second strap to the rotating shaft, the second strap having a second free end;
positioning a sheeting material over the operating table;
positioning the patient on the sheeting material;
releasably securing the operating table adjacent the second side of the recovery bed;
securing the first free end of the first strap and the second free end of the second strap to the sheeting material;
rotating the rotatable shaft;
rolling the first strap and the second strap roll about the rotating shaft; and
pulling the sheeting material and the patient from the operating table to the recovery bed.

15. A patient transfer system for transferring a patient from an operating table to a recovery bed, the recovery bed having a first side and a second side, the patient transfer system comprising:
a first support member capable of being mounted to the first side of the recovery table, the first support member mounted nearingly adjacent a foot end of the recovery bed;
a second support member capable of being mounted to the first side of the recovery table, the first support member spaced from the second support member;
a first hub rotatably mounted to the first support member;
a second hub rotatably mounted to the second support member;
a rotatable shaft mounted between the first hub and the second hub;
a first spool mounted to the rotating shaft between the first hub and the second hub;
a first strap secured to the first spool, the first strap having a first free end;
a second strap secured to the second hub, the second strap having a second free end;
a sheeting material positionable over the operating table, the first free end of the first strap and the second free end of the second strap releasably secured to the sheeting material; and
a cranking mechanism for rotating the rotatable shaft;
wherein upon positioning the sheeting material on the operating table, positioning the patient upon the sheeting material, releasably securing the operating table adjacent the second side of the recovery bed, and rotating the rotatable shaft with the cranking mechanism, the first strap spools about the first spool and the second strap spools about the second hub and pulls the sheeting material and the patient from the operating table to the recovery bed; and
wherein the patient transfer system allows transfer of the patient from the operating table to the recovery bed without physical strain.

16. The patient transfer system of claim 15 wherein the cranking mechanism is a manually operated hand crank mounted to the first hub.

17. The patient transfer system of claim 15 wherein the cranking mechanism is a motor activatable by operating controls either remotely situated or mounted directly to the hospital bed.

18. The patient transfer system of claim 15 wherein the first spool is fixedly secured to rotating shaft, first spool rotating with the rotation of the rotating shaft.

19. The patient transfer system of claim 18 wherein the first spool is fixedly secured to the rotating shaft at a position nearingly adjacent the first hub at a position closer to the first hub than the second hub.

20. The patient transfer system of claim 15 wherein the first spool is slidably mounted along the rotating shaft, and further comprising:
a locking mechanism for releasably securing the first spool in a desired position along the rotating shaft, the first spool rotating with the rotation of the rotating shaft.
